(19) United States
(12) Patent Application Publication
(10) Pub. No.: US 2018/0242786 A1
(43) Pub. Date: Aug. 30, 2018

(54) GRILL PAN FOR LOAVES OF FOOD

(71) Applicant: Rachael Kearse Best, Columbia, SC (US)

(72) Inventor: Rachael Kearse Best, Columbia, SC (US)

(21) Appl. No.: 15/902,650

(22) Filed: Feb. 22, 2018

Related U.S. Application Data
(60) Provisional application No. 62/462,998, filed on Feb. 24, 2017.

(51) Int. Cl. A47J 37/07; A47J 43/28

(52) U.S. Cl. CPC A47J 37/0786; A47J 43/18; A47J 43/288

(57) ABSTRACT

A grill pan for loaves of food is characterized by a food support having a plurality of apertures formed therein and a bottomless container having peripheral walls that define an area between the walls. The bottomless container is so constructed and arranged to be positioned over the plurality of apertures of the food support plate.

The bottomless container has food positioned therein. Food in the bottomless container is exposed to heat, such as infrared and/or convective heat, to cook the food in the container.

This Application claims the benefit of U.S. Provisional Application No. 62/462,998 filed Feb. 24, 2017.

### BACKGROUND OF THE INVENTION

For many years, most outdoor grills were used primarily for cooking traditional meats—hamburgers, hotdogs, steaks, pork chops, and chicken. In recent years, the popularity of outdoor kitchens has been a factor in a developing trend to use outdoor grills for cooking other types of food that require less intense heat and slower cooking. Outdoor grills are now being used to cook such foods as vegetables, fruits, pizza and fish. Turkeys, roasts, and other larger cuts of meat can be cooked slowly on outdoor grills, and some of these grills also provide a method to smoke the meat for several hours. Cooking times for slower cooking vary with different types of meats. For an example, pulled pork can take as long as 12 hours to properly cook at very low heat settings.

It is commonly recognized that grilling significantly reduces the saturated fat content of meat and fish. This is because the grill grates that support the food while it cooks allow the melted fat from meat and fish to drip off and away from the food. Another benefit to this cooking process is that the fat drippings then come in contact with the heated surface of the grill or charcoal and create the rich, smoky vapor that gives grilled food a charbroiled flavor. However, when fish and meat are cooked in a pan, either on a stove or in an oven, the melted fat from the food pools around it in the pan, some of which is ultimately reabsorbed by the food. This is also true when meat and fish are cooked in a pan on a grill and because the fat drippings cannot drain away from the food, they cannot contact the heated surface of the grill or charcoal and create the smoky vapor that imbues food with an outdoor grilled flavor.

It is desirable to cook loaves of meat, such as ground meat, on a grill for the reasons stated above. The mixtures of the ingredients of a loaf of prepared meat are not usually self-supporting until the loaf is at least partially cooked. Therefore, it is not practical to cook the loaf on a surface containing perforations, such as a grill, since the loaf tends to spread, unable to hold its shape.

### SUMMARY OF THE INVENTION

A grill pan for loaves of food is characterized by a food support having a plurality of apertures formed therein and a bottomless container having peripheral walls that define an area between the walls. The bottomless container is so constructed and arranged to be positioned over the plurality of apertures of the food support plate.

The bottomless container has food positioned therein. The food in the bottomless container is exposed to heat, such as infrared and/or convective heat, to cook the food in the container.

### SUMMARY OF THE DRAWING

FIG. 1 is a perspective view of a preferred embodiment of the grill pan of the invention.

FIG. 2 shows a method of use of the grill pan of FIG. 1.

### DESCRIPTION OF PREFERRED EMBODIMENTS

This invention provides a device and method that permits the use of grills for cooking various types of loaves of meat. In accordance with an embodiment of the present invention, the loaf container has multiple side walls (usually four) with an open top. The container has an open bottom but is used with a food support as described herein. The number of walls is not limited to four, and the container may also be round or have arcuate walls. The size and shape of the container determines the size and shape of the loaf.

Meat or other food is positioned in the area between the walls of the container. The meat or other food may be tightly packed between the walls of the container.

A preferred embodiment of this invention includes a food support having a plurality of spaced apart voids or apertures therein. The food support supports the meat or other food items while permitting the meat or other food to be exposed to thermal energy. The horizontal surface of the food support contains spaced apart voids or apertures through which heat energy (convective and/or infrared) can pass through to the bottom side of the loaf of food. The apertures of the food support also allow melted fat to drain away from the loaf of meat as it cooks, which not only prevents the fat from being reabsorbed by the meat, but also provides a conduit through which fat drippings are introduced to the heated grill, creating the rich, smoky vapor that gives food cooked on grills a charbroiled flavor.

In a preferred embodiment, the handle of the food support is selectively detachable, allowing the handle to be detached from the horizontal food support during grilling and then reattached when it is time to remove the food from the grill, thus preventing the handle from overheating. However, the handle of the food support may or may not be removable, and the perforated food support that serves as the bottom of the container may or may not have a handle at all.

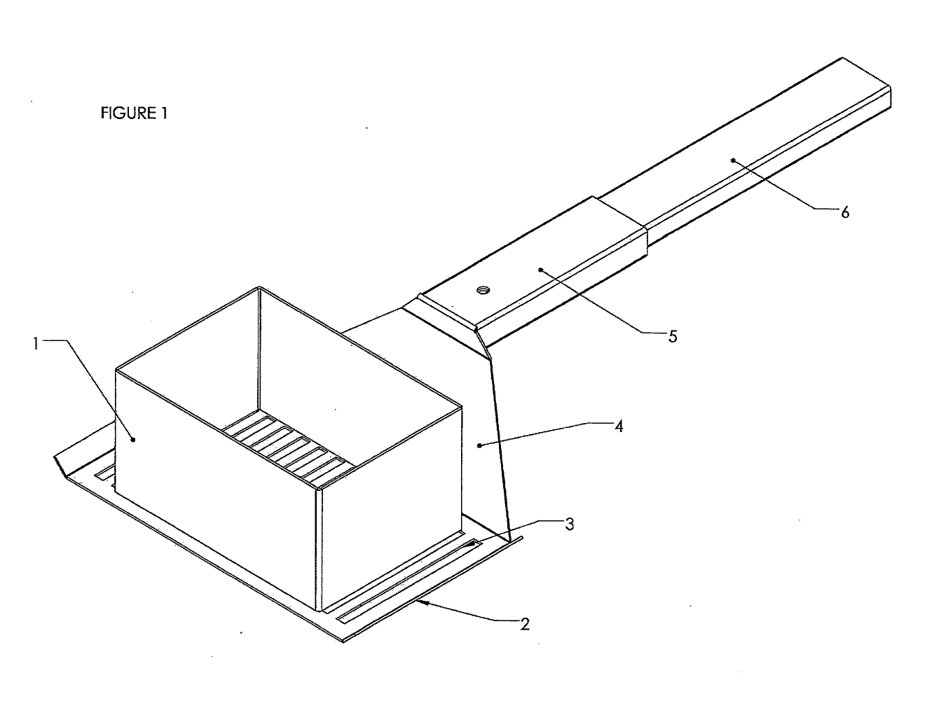

Referring now to the drawing, FIG. 1 depicts a preferred embodiment of the invention. A housing or container 1 for the grill pan of the invention may be in the shape of a rectangle as shown. The grill pan may be formed in other geometric shapes such as a triangle or circle. However, the most practical shapes are a rectangle or a square for most applications. The container is bottomless, meaning that at least 90% of the area of the bottom of the container is open and uncovered.

A food support 2 is preferred to be used with the invention. The food support may be a flat, planar device having apertures 3 formed therein through which heat energy (convective and/or infrared) passes through to the bottom side of a loaf of meat contained in the container. The apertures 3 allow melted fat that is produced when cooking meatloaf or other food items to drain away from the food so that the fat will not be in contact with the food, which may lead to reabsorption of the fat.

In a preferred embodiment, the container 1 is not attached to the food support 2, but rests upon the food support so that the food support member may be removed by pulling the food support away from the container, or by pulling the container away from the food support. This feature allows the same container to be used with food supports having apertures of varying sizes and configurations, or no apertures at all. The aperture geometry will vary according to the food used with the container, the heat source used, and personal preferences of the user. The container may be shifted on the food support during cooking to allow different portions of the bottom of the food to be exposed to direct heat though the apertures. By not being attached to the food support, the food container may be lifted away from the food support for removal of food from the container or for further cooking without the food support.

A connector 4 attaches the food support 2 to a stationary handle 5 in the embodiment shown. As shown, the handle extends above and away from the food support. The stationary handle 5 may provide a channel for receiving a removable handle 6. The removable handle 6 may be removed while the meat loaf or other food item is cooking on the grill so that it will remain sufficiently cool to the touch but can be re-attached to remove the food support container and cooked food. The handle 6 may not be removable, but if not, insulating material (such as a glove or cloth) should be used when the apparatus and cooked food are removed from the grill, similar to removing a hot dish from a conventional oven. Furthermore, the perforated flat food support 2 may or may not comprise a handle.

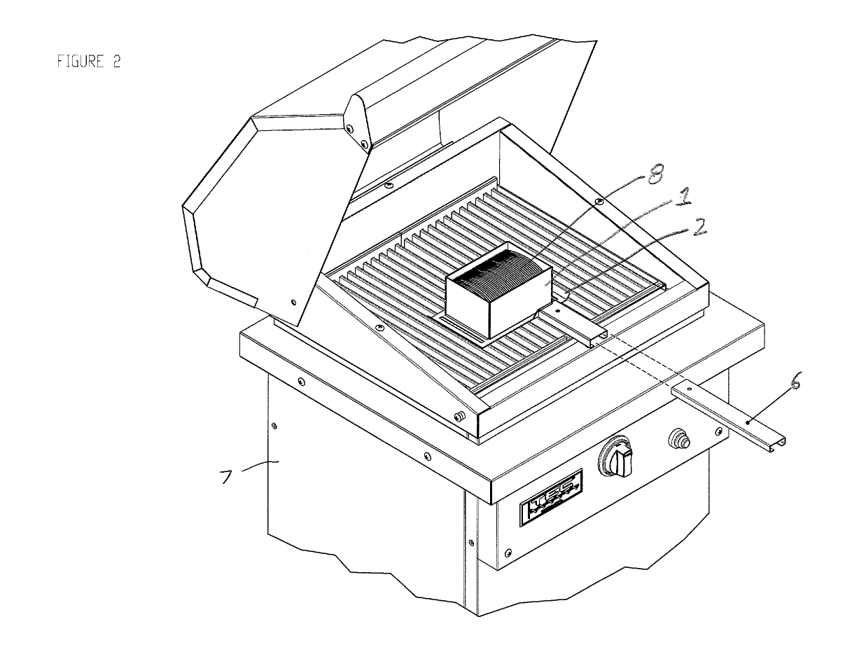

In use, the container 1 is positioned on the food support 2 prior to positioning the meat, such as a meat loaf mixture, or other food item into it. The meat or other food item is formed as a loaf 8 as it is packed into the container. FIG. 2. The food support at least initially serves as the bottom of the container 1. After the loaf mixture or other food item is placed into the container, the apparatus is placed on the grates of a grill 7 by means of the handle (if used) with the food support in place beneath the container. Heat energy from the grill, convective and/or infrared, passes through the apertures 3 of the food support so that the bottom of the loaf will cook in part by convective and/or infrared energy rather than solely by conduction. When a crust or browning on the bottom of the loaf has occurred, the loaf tends to stabilize and is held together, assisted by the walls of the container. At this point, the food support plate may be removed in a preferred embodiment so that the open area of the bottom of the container allows the loaf to be exposed to the direct heat energy of the grill. However, the food support may remain in place throughout the cooking process with good results and may be attached to the container. When the loaf of meat is cooked as desired, the loaf is easily removed from the container due to shrinkage of the loaf during the cooking process.

What is claimed:

1. A grill pan for loaves of food, comprising:
a) a food support plate;
b) a bottomless container having peripheral walls that define an area between the walls, the bottomless container constructed and arranged to be positioned above the food support plate, wherein the bottomless container is not connected to the food support plate; and
c) a handle extending outwardly from the food support plate so constructed and arranged to facilitate positioning the food support plate under the bottomless container and removing the food support plate from under the bottomless container.

2. The grill pan for loaves of food as described in claim 1 wherein the bottomless container is not attached to the food support plate.

3. The grill pan for loaves of food as described in claim 1 wherein a removable handle is inserted into a stationary handle to form a handle construct, and the temporary handle is removable from the stationary handle by withdrawing the temporary handle from the stationary handle.

4. The grill pan for loaves of food as described in claim 1 wherein the food support member comprises a top surface that is flat and generally planar and a bottom surface that is flat and generally planar.

5. The grill pan for loaves of food as described in claim 1 wherein the food support plate comprises a plurality of apertures formed therein, and the bottomless container is positioned over the plurality of apertures of the food support plate.

6. The grill pan for loaves of food as described in claim 4 wherein the handle extends above the food support plate.

7. A method of cooking food using the grill pan as described in claim 1, comprising the steps of:
positioning the bottomless container over the food support;
packing the bottomless container with food;
placing the bottomless container and the food support over a heat source; and
transferring heat to the food in the bottomless container.

8. The method of cooking food using the grill pan according to claim 7, wherein the food comprises ground meat.

9. The method of cooking food using the grill pan according to claim 7, wherein the heat source is infrared radiation.

10. The method of cooking food using the grill pan according to claim 7, wherein the heat source is heated gas.

11. The method of cooking food using the grill pan according to claim 7, wherein the food support plate comprises a plurality of apertures formed therein, and the step of positioning the bottomless container over the food support comprises positioning the bottomless container support plate over the plurality of apertures of the food support plate.
